(19) United States
(12) Patent Application Publication
(10) Pub. No.: US 2022/0138632 A1
(43) Pub. Date: May 5, 2022

(54) RULE-BASED CALIBRATION OF AN ARTIFICIAL INTELLIGENCE MODEL

(71) Applicant: Accenture Global Solutions Limited, Dublin (IE)

(72) Inventors: Christophe GUERET, Co. Dublin (IE); Luca COSTABELLO, Newbridge (IE)

(21) Appl. No.: 16/949,442

(22) Filed: Oct. 29, 2020

(51) Int. Cl. G06N 20/20

(52) U.S. Cl. CPC G06N 20/20

(57) ABSTRACT

A device may receive calibration data associated with a plurality of units and receive a set of rules; determine, based on the set of rules, a plurality of groups associated with the plurality of units; and process the calibration data based on a pretrained artificial intelligence (AI) model. The device may determine, based on processing the calibration data, a prediction that is associated with a group of the plurality of groups; and determine, based on the set of rules, a target associated with the group based on the set of rules. The device may generate a calibration model based on the prediction and the target, and aggregate the calibration model with another calibration model that is associated with another group of the plurality of groups to form a calibrated AI model.

### BACKGROUND

Through advanced, human-like intelligence (e.g., provided by software and hardware), an artificial intelligence model can mimic human behavior or perform tasks as if the artificial intelligence model were human. Machine learning is an approach, or a subset, of artificial intelligence with an emphasis on learning rather than just computer programming. In machine learning, a device utilizes complex models to analyze a massive amount of data, recognize patterns among the data, and make a prediction without requiring a person to program specific instructions.

### SUMMARY

In some implementations, a method includes receiving calibration data associated with a plurality of units and receiving a set of rules; determining, based on the set of rules, a plurality of groups associated with the units; processing, based on a first artificial intelligence (AI) model, the calibration data to determine a first prediction that is associated with a first group of the plurality of groups; determining a first target associated with the first group based on the set of rules; generating a first calibration model based on the first prediction and the first target; and processing, based on the first AI model, the calibration data to determine a second prediction that is associated with a second group of the plurality of groups; determining a second target associated with the second group based on the set of rules; generating a second calibration model based on the second prediction and the second target; aggregating the first calibration model and the second calibration model to form a second AI model; and performing an action associated with the second AI model.

In some implementations, a device includes one or more memories; and one or more processors, communicatively coupled to the one or more memories, configured to: receive a pretrained AI model and calibration data associated with a plurality of units and a set of rules; determine, based on the set of rules, a plurality of groups associated with the plurality of units; assign a first subset of the calibration data to a first group of the plurality of groups and a second subset of the calibration data to a second group of the plurality of groups; process, based on the pretrained AI model, the first subset of the calibration data to determine a first prediction that is associated with the first group; process, based on the pretrained AI model, the second subset of the calibration data to determine a second prediction that is associated with the second group; determine, based on the set of rules, a first target associated with the first group and a second target associated with the second group; generate a first calibration model based on the first prediction and the first target and a second calibration model based on the second prediction and the second target; aggregate the first calibration model and the second calibration model to form a calibrated AI model; and perform an action associated with the calibrated AI model.

In some implementations, a non-transitory computer-readable medium storing a set of instructions includes one or more instructions that, when executed by one or more processors of a device, cause the device to: receive calibration data associated with a plurality of units and a set of rules; determine, based on the set of rules, a plurality of groups associated with the plurality of units; process the calibration data based on a pretrained AI model; determine, based on processing the calibration data, a prediction that is associated with a group of the plurality of groups; determine, based on the set of rules, a target associated with the group based on the set of rules; generate a calibration model based on the prediction and the target; aggregate the calibration model with another calibration model that is associated with another group of the plurality of groups to form a calibrated AI model; and perform an action associated with the calibrated AI model.

### BRIEF DESCRIPTION OF THE DRAWINGS

FIGS. 1A-1C are diagrams of an example implementation associated with rule-based calibration of an artificial intelligence model as described herein.

FIG. 2 is a diagram illustrating an example of training and using a machine learning model in connection with calibrating an artificial intelligence model.

FIG. 3 is a diagram illustrating an example of applying a trained machine learning model to a new observation associated with calibrating an artificial intelligence model.

FIG. 4 is a is a diagram of an example environment in which systems and/or methods described herein may be implemented.

FIG. 5 is a diagram of example components of one or more devices of FIG. 4.

FIG. 6 is a flowchart of an example process relating to calibrating an artificial intelligence model.

### DETAILED DESCRIPTION

The following detailed description of example implementations refers to the accompanying drawings. The same reference numbers in different drawings may identify the same or similar elements.

An artificial intelligence (AI) model may be trained using one or more datasets to predict an outcome and/or qualification. For example, the AI model may be trained using one or more datasets (e.g., regarding different metrics to qualify individuals to receive different services) to predict whether an individual is qualified to receive a service, product, membership, or the like. In some instances, the one or more datasets used to train the AI model may be incomplete and/or inaccurate because the one or more datasets do not include sufficiently balanced data regarding one or more groups of individuals. As a result of the one or more datasets being incomplete and/or inaccurate, the AI model may provide biased predictions for individuals belonging to these groups. Accordingly, the AI model may incorrectly predict that an individual (belonging to a group with an incomplete or inaccurate representation in the dataset) is not qualified to receive a particular service, product, membership, or the like.

Use of an AI model that provides inaccurate predictions may provide undesired results, provide results that negatively impact a system or a user of the system, and/or waste computing resources (e.g., processor resources, memory resources, storage resources, or the like), network resources, and/or communication resources of the system that may be required to remedy any negative effect resulting from inaccurate predictions. One possible way to resolve the inaccurate predictions of the AI model is to train the AI model using additional data (e.g., until the data associated with each of the groups is accurately balanced and/or complete relative to other groups associated with the dataset). However, the additional data may waste computing resources, network resources, and/or storage resources because the additional datasets may include a large amount of data that require an increased amount of storage resources (e.g., to maintain the large amount of data) and/or processing/memory resources (e.g., to analyze the large amount of data). Furthermore, accumulating this additional data can take a relatively long period of time, leading to delays in being able to accurately train an AI model.

Some implementations described herein provide a model calibration system that uses a set of rules to drive a calibration of an AI model to account for incompleteness and/or inaccuracies of a dataset that was used to train the AI model (e.g., based on fairness objectives and/or identified biases of the dataset). For example, the model calibration system may receive calibration data associated with a plurality of units and a set of rules; determine, based on the set of rules, a plurality of groups associated with the plurality of units; and process the calibration data based on a pretrained AI model. The model calibration system may determine, based on processing the calibration data, a prediction that is associated with a group of the plurality of groups; determine, based on the set of rules (e.g., rules that define classes, rules that provide fairness objectives for the classes, or the like), a target associated with the group based on the set of rules; generate a calibration model based on the prediction and the target; and aggregate the calibration model with another calibration model that is associated with another group of the plurality of groups to form a calibrated AI model. The model calibration system may perform an action associated with the calibrated AI model.

By generating a calibration model based on the set of rules (that drive a calibration of an AI model), the model calibration system may conserve computing resources, network resources, and/or communication resources that would have otherwise been used to remedy negative effects resulting from inaccurate predictions based on incomplete or inaccurate datasets. Additionally, by generating a calibration model based on the set of rules (that drive a calibration of an AI model), the model calibration system may preserve computing resources, network resources, and/or storage resources that would been used to train the AI using relatively large amounts of data collected in an effort to generate a more complete or accurate dataset.

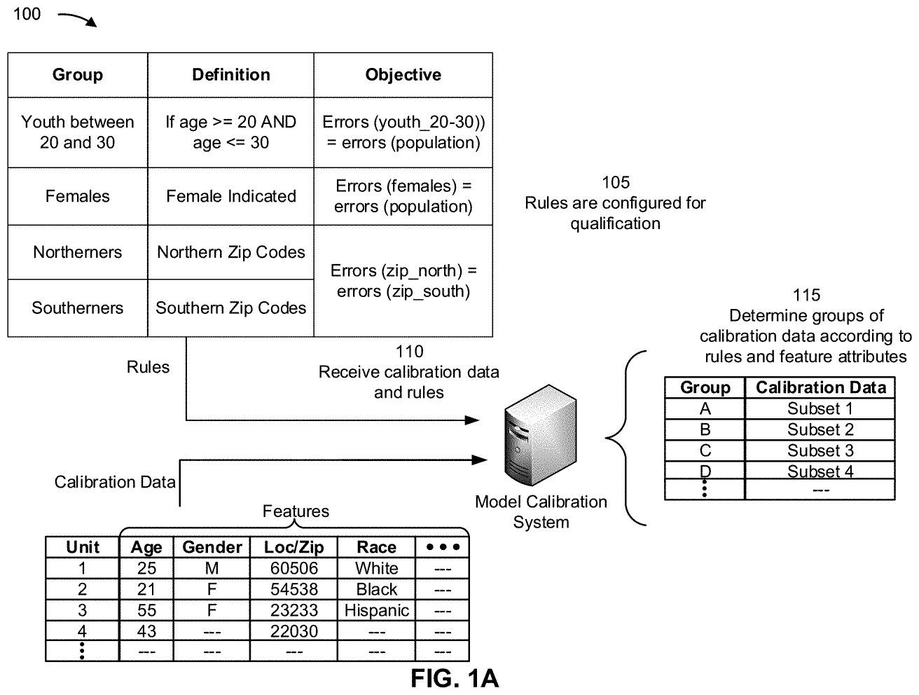

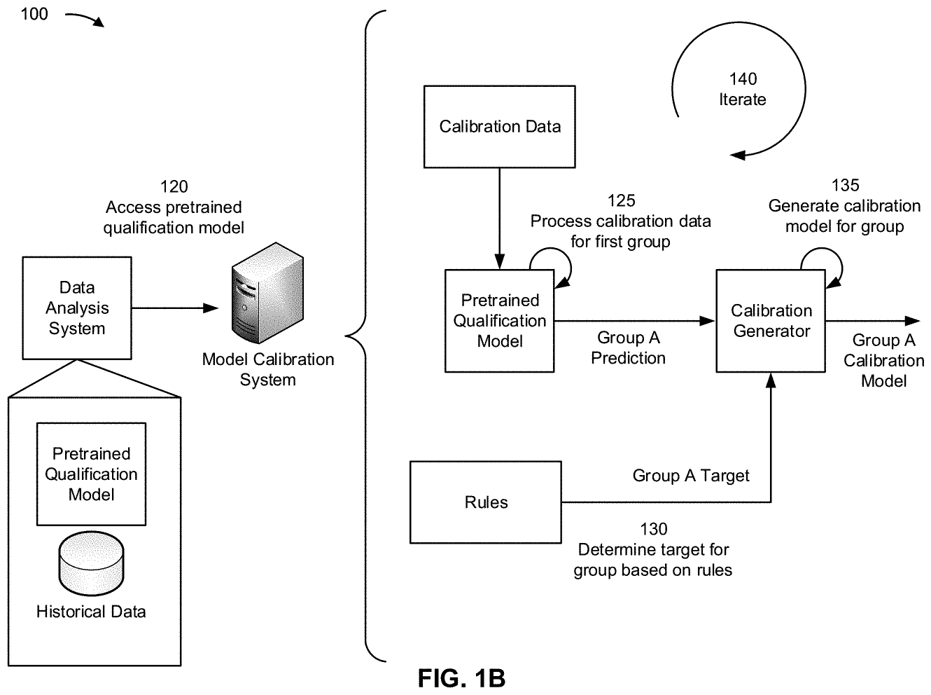

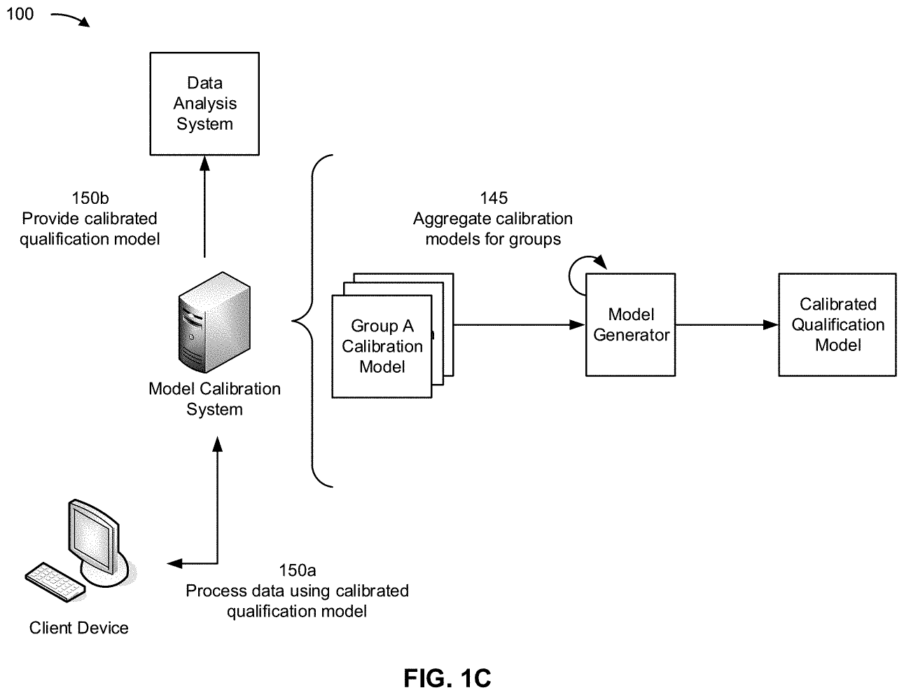

FIGS. 1A-1C are diagrams of an example 100 associated with calibrating an AI model as described herein. As shown in FIGS. 1A-1C, example 100 includes a model calibration system, a user device, a data analysis system, and a reference information platform. In example 100, the model calibration system includes and/or is associated with the data analysis system. The model calibration system includes a calibration generator model and a model generator.

The data analysis system may include and/or be associated with a pretrained qualification model. The pretrained qualification model may be configured to qualify a user or individual (which may be referred to herein as a “unit”) for a service (e.g., a technological service, a financial service, a transportation service, and/or the like), a product (e.g., a media-based product, a consumer good, or the like), a membership (e.g., in a class, in an environment, in an organization, according to a certification group, or the like) according to user information using any suitable technique. For example, to qualify for a telecommunication service at a particular location, the user information may include an address of the user, financial information of the user, a desired level of service of the user, and/or the like. As another example, for a loan application, the user information may include income of the user, debt of the user, a credit rating of the user, assets of the user, an amount of the loan, and/or the like. Additionally, or alternatively, the user information may include individual characteristics of the user, such as age, gender, race, ethnicity, income, occupation, geographical location, and/or other distinguishable characteristics. The qualification model may determine, predict, and/or indicate whether the user is qualified for the service or product based on one or more parameters of the user information and one or more metrics for meeting a particular qualification (e.g., for a service, a product, a membership, or the like). The qualification model may be a binary classification model that provides a binary output (e.g., “qualified” or “not qualified”). Additionally, or alternatively, the qualification model may determine and/or indicate a confidence score associated with a prediction of whether the user is qualified. The confidence score may correspond to a probability that the user is qualified or a probability that the user is not qualified.

As shown in FIG. 1A, and by reference number 105, rules may be configured for qualification. For example, the rules may be configured according to a user input to the model calibration system, according to reference information associated with one or more groups (e.g., statistical information, analytical information, heuristics, or the like). The set of rules may define respective features of the plurality of groups and respective fairness objectives for the plurality of groups. In some implementations, the rules are preconfigured for the one or more groups based on one or more qualification metrics associated with meeting the particular qualification that is analyzed by the pretrained qualification model of the data analysis system.

In example 100, a set of example rules are provided for four example groups: Youth (specifically 20 to 30 year old individuals), Females, Northerners, and Southerners. An example rule, as described herein, includes a definition and an objective. The definition defines one or more parameters associated with an individual being assigned or associated with a group (e.g., being a member of the group). Accordingly, as shown, the Youth are defined based on having an age between 20 years old and 30 years old, a Female is defined as being indicated as female, a Northerner is defined as an individual having or being associated with a northern zip code (e.g., based on home address, work address, or the like), and a Southerner is defined as an individual having or being associated with a southern zip code.

As shown in example 100, a first group may be associated with a different feature than a second group (e.g., Youth are associated with age, and Females are associated with gender). Additionally, or alternatively, in some implementations described herein, a first group, for example Youth, may be associated with a same attribute as a second group (an “Experienced” group). In such a case, the first group may be associated with a first attribute of the age feature (such as having an age between 20 and 30), and the second group may be associated with a second attribute (e.g., an older age range) of the age feature.

The objective corresponds to a desired target for analyzing individuals in that group regardless of a level of accuracy of a dataset for the group or regardless of a level of completeness of a dataset for the group, as described herein. Correspondingly, the objective for Youth and the objective for Female are to have a same error rate (e.g., false positive error rate, false negative error rate, or the like) as a population associated with a dataset (e.g., a population that includes Youth). The objective for the group Northerners is to have a same error rate as the group Southerners, and the objective for the group Southerners is to have a same error rate as the group Northerners.

In this way, rules may be configured for a pretrained qualification model to permit the model calibration system to calibrate the pretrained qualification model based on the set of rules.

As further shown in FIG. 1A, and by reference number 110, the model calibration system may receive calibration data and the rules. For example, the model calibration system may receive the calibration data and the rules in association with a request to calibrate the pretrained qualification model. As shown, the calibration data may include data associated with a set of units and feature data associated with a set of features of the units. In example 100, the set of features include an age of the unit, a gender of the unit, a location of the unit (“Loc/Zip”), and a race of the unit. Values of the features may correspond to particular attributes of the units. For example, Unit 1 has attributes of being 25 years old, male, located in a northern zip code (based on 60506 being designated as a northern zip code), and white. In some implementations, the calibration data may correspond to a particular set of data (e.g., historical data) associated with training the pretrained qualification model. Additionally, or alternatively, the calibration data may correspond to a set of data for evaluating the pretrained qualification model. As described herein, the calibration data may be used to calibrate the pretrained qualification model according to the received set of rules.

In some implementations, the calibration data further includes respective profile data associated with profiles of the units that are analyzed relative to a profile threshold with respect to meeting one or more qualifications. For example, a profile of the units may include information associated with one or more qualification metrics (or other similar features) that are used to qualify the unit regardless of certain attributes of the units. For example, a profile of a user seeking qualification for a bank loan may include financial information associated with the user (e.g., income, debt to income ratio, worth of assets of the user, or the like). The profile threshold may correspond to a threshold score that is determined based on a suitable scoring system (e.g., a linear scoring system, an exponential scoring system, a weighted average scoring system, or the like). In this way, the calibration data may include profile data associated with respective profiles of the units to permit one or more models described herein to qualify one or more units, as described herein.

In this way, the model calibration system may receive rules that are associated with a pretrained qualification model to permit the model calibration system to calibrate the pretrained qualification model based on the set of rules.

As further shown in FIG. 1A, and by reference number 115, the model calibration system may determine groups of calibration data according to rules and feature attributes. For example, based on the attributes of certain features and/or the definitions of the groups, calibration data for units may be assigned to subsets associated with the groups. The model calibration system may use any suitable technique (e.g., natural language processing, optical character recognition, text recognition, or the like) to analyze, sort, and/or assign calibration data to corresponding groups based on the attributes and/or features of the calibration data and the defined groups in the set of rules. In example 100, the calibration data for Unit 1 may be assigned to a Youth subset and a Northerner subset (e.g., due to 60506 being designated as a northern zip code). Correspondingly, the model calibration system may assign calibration data for units to groups that are defined in the rules. In this way, a unit may be associated with the first subset of the calibration data and the second subset of the calibration data.

As shown, a Group A may be associated with Subset 1 of calibration data, a Group B may be associated with Subset 2, a Group C may be associated with a Subset 3, and a Group D may be associated with a Subset 4. Group A, Group B, Group C, and/or Group D may correspond to and/or be associated with (e.g., be included within and/or combined with) one or more of the groups (e.g., Youth, Females, Northerners, and Southerners) specified in the definitions of the rules.

In this way, the model calibration system may determine, based on the set of rules, a plurality of groups associated with the plurality of units and assign subsets of the calibration data to corresponding groups of the plurality of groups.

As shown in FIG. 1B, and by reference number 120, the model calibration system may access the pretrained qualification model. For example, the model calibration system may receive and/or obtain the pretrained qualification model in association with or based on receiving a request (e.g., from the data analysis system) to calibrate the pretrained qualification model according to the calibration data and/or the rules.

As shown in example 100, the data analysis system may include and/or be associated with a historical data structure. The historical data structure may include historical training data that was used to train the pretrained qualification model. As described herein, the historical training data may include incomplete and/or inaccurate data that caused the pretrained qualification model to develop a bias (e.g., with respect to qualifying units based on certain attributes and/or features) that causes the pretrained qualification model to inaccurately qualify or disqualify units according to certain qualification metrics of the pretrained qualification model. In some implementations, the calibration data is associated with and/or corresponds to a subset of the historical training data (e.g., a most recently generated or received set of historical training data). In some implementations, the model calibration system may receive the historical training data in association with obtaining the pretrained qualification model.

In this way, the model calibration system may access and/or receive the pretrained qualification model in association with the calibration data and/or the rules to permit the model calibration system to calibrate the pretrained qualification model, as described herein.

As further shown in FIG. 1B, and by reference number 125, the model calibration system may process calibration data for a first group. For example, the model calibration system may use the pretrained qualification model to determine one or more predictions associated with a first group, of the plurality groups (shown as Group A), based on a subset of the calibration data associated with the first group (e.g., based on Subset 1).

Based on processing the subset of the calibration data for the first group and/or determined predictions from processing the subset of the calibration data, the model calibration system may determine an error rate associated with predicting an outcome of the pretrained qualification model based on profile data for the first group and/or a profile threshold of the qualification model. The error rate may be associated with the pretrained qualification model determining that units of the first group are associated with profiles that satisfy the profile threshold and/or that the units of the first group are not associated with profiles that satisfy the profile threshold. For example, the model calibration system may determine a rate of false positives (e.g., a rate of erroneously qualifying a unit associated with the first group), a rate of false negatives (e.g., a rate of erroneously disqualifying a unit associated with the first group), or the like. The model calibration system may determine the error rate based on comparing one or more of the predictions with user feedback (e.g., similar to a supervised learning technique) and/or based on information that identifies results associated with qualifying units of the first group.

In this way, the model calibration system may process the calibration data using the pretrained qualification model to determine one or more predictions associated with a particular group to permit the model calibration system to calibrate the pretrained qualification model based on a target for the group.

As further shown in FIG. 1B, and by reference number 130, the model calibration system may determine a target for a group based on rules. For example, as shown, the model calibration system may determine the target for the first group (Group A) based on the received rules. In some implementations, the target may correspond to and/or be based on the one or more objectives of a particular group. For example, the target may be associated with a fairness objective that configures the group to be analyzed according to another error rate associated with one or more other groups of units associated with the calibration data. More specifically, the target may correspond to setting an error rate for Group A according to an error rate for Group B. Additionally, or alternatively, the target may correspond to setting an error rate for a combination of groups (e.g., the error rate for all groups associated with the calibration data, the error rate for a subset of groups associated with the calibration data, or the like).

In this way, the model calibration system may determine a target for a group based on the received rules to permit the model calibration system to generate a calibration model for the group based on the target and a prediction (and/or error rate) for a group.

As further shown in FIG. 1B, and by reference number 135, the model calibration system may generate a calibration model for a group. For example, the model calibration system may generate the calibration model for the group based on one or more predictions associated with the group (determined by processing the calibration data) and the target. The model calibration system may generate the calibration model using a scaling technique (e.g., a Platt scaling technique, an exponential scaling technique, an averaging technique, a weighted averaging technique, or the like), using a regression technique (e.g., an isotonic regression technique, and/or a linear regression technique, among other examples), or the like.

The calibration model for the group is configured to determine a prediction according to a rule (and/or an objective) that is associated with the group. Accordingly, rather than using only historical data (and/or training data) associated with a particular group (as performed by the pretrained qualification model), the calibration model is generated and/or configured to predict an outcome based on one or more rules for the group.

In this way, the model calibration system may generate a calibration model for the one or more groups of units associated with the calibration data, based on the rules, to permit the model calibration system to generate a calibrated AI model that is based on the pretrained qualification model.

As further shown in FIG. 1B, and by reference number 140, the model calibration system iterates one or more of the above processes for one or more other groups of the plurality of groups. For example, the model calibration system may iteratively process calibration data for another group (e.g., Group B, Group C, and/or Group D), determine a target for the remaining group, and generate a calibration model for the remaining group.

In this way, the model calibration system may generate a plurality of calibration models for a plurality of groups associated with the calibration data to permit the model calibration system to aggregate the plurality of calibration models to form a calibrated AI model, such as a calibrated qualification model that is based on the pretrained qualification model.

As shown in FIG. 1C, and by reference number 145, the model calibration system may aggregate calibration models for groups. For example, the model calibration system may combine (e.g., according to an averaging technique, a consensus technique, and/or any or similar combination technique) a first calibration model associated with a first group (e.g., Group A) with a second calibration model that is associated with a second group (e.g., Group B) to form a calibrated qualification model. The calibrated qualification model may correspond to an updated version of the pretrained qualification model, a separate model from the pretrained qualification model (e.g., a replacement for the pretrained qualification model), or the like.

The aggregated calibration models may be configured, as described herein, to consider rules associated with the one or more groups. Accordingly, based on the rules, the calibrated qualification model may avoid developing a bias associated with one or more groups based on a limited amount of available data for the one or more groups and/or based on inaccurate data associated with the particular group. Furthermore, as described herein, the calibrated qualification model may be configured to determine a prediction for a particular unit that is associated with multiple groups, thereby preventing a bias associated with one group from affecting an outcome for a unit that is a member of a certain other group (e.g., regardless of whether the pretrained qualification model has developed a bias associated with the other group).

In this way, the model calibration system may aggregate calibration models associated with multiple groups, defined by one or more rules, to permit the model calibration system and/or the data analysis system to perform one or more actions associated with a calibrated qualification model generated from the calibration models.

As further shown in FIG. 1C, and by reference number 150a, the model calibration system may process data using the calibrated qualification model. For example, the model calibration system may reprocess the calibration data using the calibrated qualification model (e.g., to evaluate the calibrated qualification model), to determine and/or provide one more calibrated predictions associated with the units of the calibration data, and/or the like.

According to some implementations, the model calibration system may process input data using the calibrated qualification model. For example, the input data may be associated with determining whether a particular unit (e.g., a user of the client device) meets one or more qualifications associated with the pretrained qualification model. Such a unit may be associated with one or more of the groups (e.g., Group A, Group B, Group C, and/or Group D) described herein. In such a case, the calibrated qualification model (e.g., as an update to the pretrained qualification model and/or as a replacement to the pretrained qualification model) can be used by the model calibration system to determine whether the particular unit meets the one or more qualifications based on profile data included in the input data and/or a profile threshold associated with qualifying the unit (e.g., without bias associated with training data of the calibrated qualification model).

In this way, the model calibration system may process data (e.g., the calibration data, received input data, or the like) to determine a qualification of a unit of one or more groups and/or qualify the unit for a particular service, product, and/or membership based on rules associated with the one or more groups.

As further shown in FIG. 1C, and by reference number 150b, the model calibration system may provide a calibrated qualification model to the data analysis system. For example, the model calibration system may provide the calibrated qualification model to replace (and/or cause the data analysis system to replace) the pretrained qualification model to permit the data analysis system to analyze input data in association with more accurately, efficiently, and fairly qualifying units associated with one or more groups, based on rules associated with the one or more groups.

In this way, the model calibration system may perform one or more actions associated with the calibrated qualification model to enable input data associated with qualifying one or more units, as members of one or groups, according to a set of rules and/or objectives associated with the one or more groups.

As indicated above, FIGS. 1A-1C are provided as an example. Other examples may differ from what is described with regard to FIGS. 1A-1C.

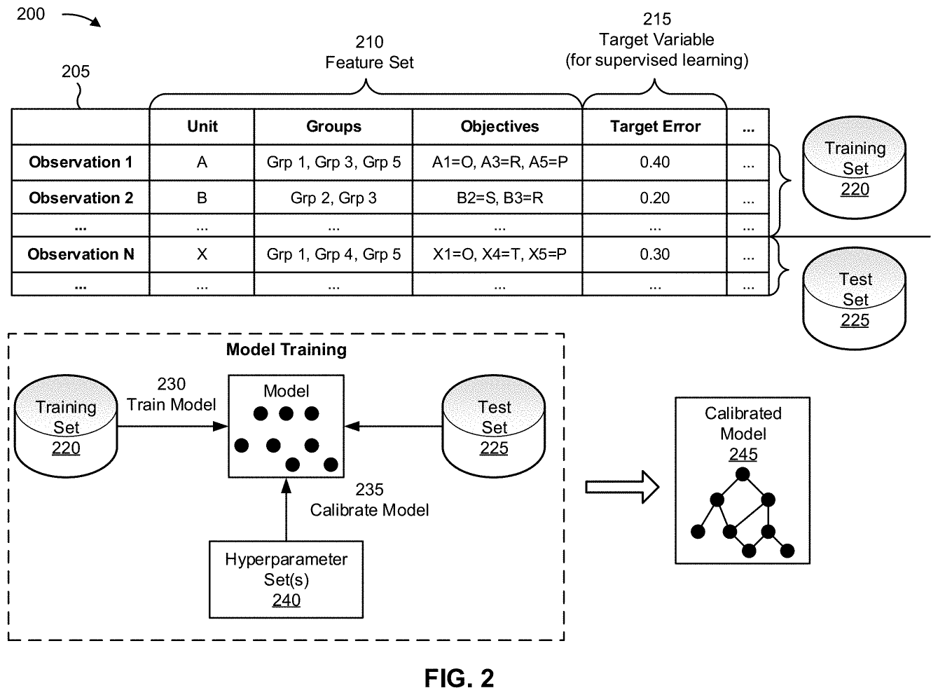

FIG. 2 is a diagram illustrating an example 200 of training a machine learning model in connection with calibrating an AI model. The machine learning model training described herein may be performed using a machine learning system. The machine learning system may include or may be included in a computing device, a server, a cloud computing environment, or the like, such as model calibration system 401, described in more detail below. In some implementations, the machine learning model training may be iteratively performed, as described herein, to generate and/or calibrate machine learning models for individual groups of units. Additionally, or alternatively, the machine learning model training may be performed, as described herein, in association with aggregating calibrated AI models that are generated and/or calibrated as described herein.

As shown by reference number 205, a machine learning model may be trained using a set of observations. The set of observations may be obtained and/or input from training data (e.g., historical data), such as data gathered during one or more processes described herein. For example, the set of observations may include data gathered from model calibration system 401, client device 430, data analysis system 440, and/or reference information platform 450, as described elsewhere herein. In some implementations, the machine learning system may receive the set of observations (e.g., as input) from model calibration system 401, client device 430, data analysis system 440, and/or reference information platform 450.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from model calibration system 401. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of “Unit,” a second feature of “Groups,” a third feature of “Objectives,” and so on. The second feature and third feature may be considered as parts of a rule, as described herein. As shown, for a first observation, the first feature may have a value of “A,” the second feature may have a value of “Grp 1, Grp 3, Grp 5,” the third feature may have a value of “A1=O, A3=R, A5=P,” and so on. Accordingly, in example 200, Unit A may be a member of groups Grp 1, Grp 3, Grp 5, that have objectives where Al=0 is an objective for group Grp 1, A3=R is an objective for group Grp 3, and A5=P is an objective for group Grp5. These features and feature values are provided as examples, and may differ in other examples. For example, the feature set may include one or more of the following features: service requested, qualification metrics, age, gender, race, ethnicity, income, occupation, geographical location, and/or other distinguishable characteristics associated with units and/or groups. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a “Target Error,” which has a value of 0.40 for the first observation. As an example, the target variable may be used to provide a recommendation and/or prediction regarding an error rate (e.g., a false positive error rate, a false negative error rate, or the like) associated with determining a qualification of an individual with respect to receiving a service. Accordingly, an individual that is similar to Unit A, as a member of groups Grp 1, Grp 3, Grp 5 that are associated with objectives A1=O, A3=R, A5=P is to be analyzed relative to a target error rate of 0.40 (e.g., 40% probability of error).

The feature set and target variable described above are provided as examples, and other examples may differ from what is described above. For example, for a target variable of an error rate of a prediction, the feature set may include a service requested, qualification metrics, age, gender, race, ethnicity, income, occupation, geographical location, and/or other distinguishable characteristics associated with units and/or groups, as described herein.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique (e.g., a binary classification technique, a score-based classification technique, or the like).

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations, of the set of observations, and a test set 225 that includes a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to calibrate the machine learning model. A hyperparameter may include a structural parameter that controls execution of a machine learning algorithm by the machine learning system, such as a constraint applied to the machine learning algorithm. For example, as described herein, a hyperparameter may include one or more rules (e.g., rule definitions, rule objectives, or the like) associated with the one or more groups. Unlike a model parameter, a hyperparameter is not learned from data input into the model. According to some implementations, to calibrate a machine learning model (or AI model), as described herein, the machine learning system may use a scaling technique (e.g., a Platt scaling technique or the like), an isotonic regression technique, or the like.

Additionally, or alternatively, an example of a hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may calibrate each machine learning algorithm using one or more hyperparameter sets 240 (e.g., predefined sets of rules that are based on operator input that identifies rules of the hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross-validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k-1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

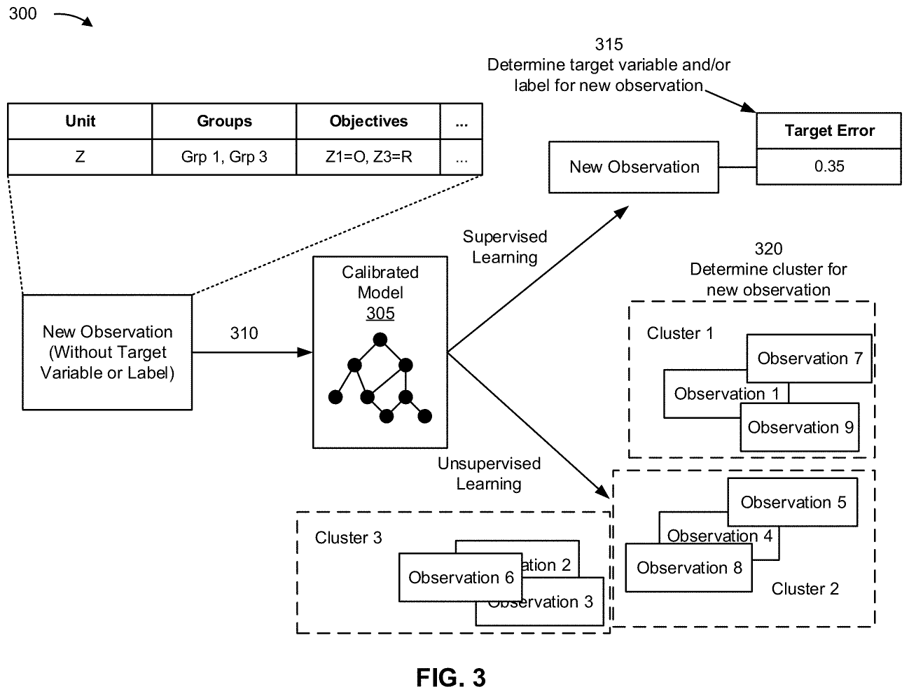

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 (e.g., for each set of rules) associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score and/or error rate that satisfies a threshold), then the machine learning system may store that machine learning model as a calibrated machine learning model 245. According to some implementations, the machine learning system may aggregate calibrated machine learning models. For example, the machine learning system may combine the machine learning model 245 with one or more other machine learning models that are trained and/or calibrated for specific groups and/or according to specific rules, as described herein. In this way, the machine learning system may generate an updated machine learning model, a retrained machine learning model, and/or a new machine learning model (e.g., as a calibrated machine learning model of a pretrained model) that can be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, a lowest error rate, or closest to a desired threshold, such as a threshold defined by one or more rules) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram illustrating an example 300 of applying a calibrated machine learning model to a new observation associated with calibrating an AI model. The new observation may be input to a machine learning system that stores a calibrated machine learning model 305. In some implementations, the calibrated machine learning model 305 may be the calibrated machine learning model 245 described above in connection with FIG. 2. The machine learning system may include or may be included in a computing device, a server, or a cloud computing environment, such as model calibration system 401, client device 430, data analysis system 440, and/or reference information platform 450.

As shown by reference number 310, the machine learning system may receive a new observation (or a set of new observations), and may input the new observation to the calibrated machine learning model 305. As shown, the new observation may include a first feature of a “Unit,” a second feature of “Groups,” a third feature of “Objectives,” and so on, as an example. The machine learning system may apply the calibrated machine learning model 305 to the new observation to generate an output (e.g., a result). The type of output may depend on the type of machine learning model and/or the type of machine learning task being performed. For example, the output may include a predicted (e.g., estimated) value of a target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the calibrated machine learning model 305 may determine and/or predict a value of 0.35 for the target variable of Target Error for the new observation, as shown by reference number 315. Based on this prediction (e.g., based on the value having a particular label or classification or based on the value satisfying or failing to satisfy a threshold), the machine learning system may provide a recommendation and/or output for determination of a recommendation, such as qualifying Unit Z, as a member of group 1 and group 3, to receive services according to the objectives of the new observation. Additionally, or alternatively, the machine learning system may perform an automated action and/or may cause an automated action to be performed (e.g., by instructing another device to perform the automated action), such as provisioning the services, facilitating an offer for the services, transmitting a message or communication associated with Unit Z being qualified or unqualified for the services, or the like. As another example, if the machine learning system were to predict a value of 0.5 for the target variable of Target Error, then the machine learning system may provide a different recommendation (e.g., request additional information) and/or may perform or cause performance of a different automated action (e.g., transmit a request for additional information). In some implementations, the recommendation and/or the automated action may be based on the target variable value having a particular label (e.g., classification or categorization) and/or may be based on whether the target variable value satisfies one or more thresholds (e.g., whether the target variable value is greater than a threshold, is less than a threshold, is equal to a threshold, or falls within a range of threshold values).

In some implementations, the calibrated machine learning model 305 may classify (e.g., cluster) the new observation in a cluster, as shown by reference number 320. The observations within a cluster may have a threshold degree of similarity. As an example, if the machine learning system classifies the new observation in a particular cluster (e.g., a cluster of observations associated with units that are members of a same set of groups), then the machine learning system may provide a recommendation and/or a prediction, analyze the groups based on a target error associated with a particular set of groups and/or objectives of the particular cluster. Additionally, or alternatively, the machine learning system may perform an automated action and/or may cause an automated action to be performed (e.g., by instructing another device to perform the automated action) based on classifying the new observation in the first cluster. For example, the machine learning system may qualify a new unit associated with the particular cluster based on a target error rate that is learned, calibrated, and/or predicted for the new cluster.

In this way, the machine learning system may apply a rigorous and automated process to calibrating an AI model (e.g., generating a calibrated AI model for a particular group of individuals) to provide balanced predictions and/or outcomes regardless of a level completeness or a level of accuracy of a dataset used to train the AI model.

As indicated above, FIG. 3 is provided as an example. Other examples may differ from what is described in connection with FIG. 3.

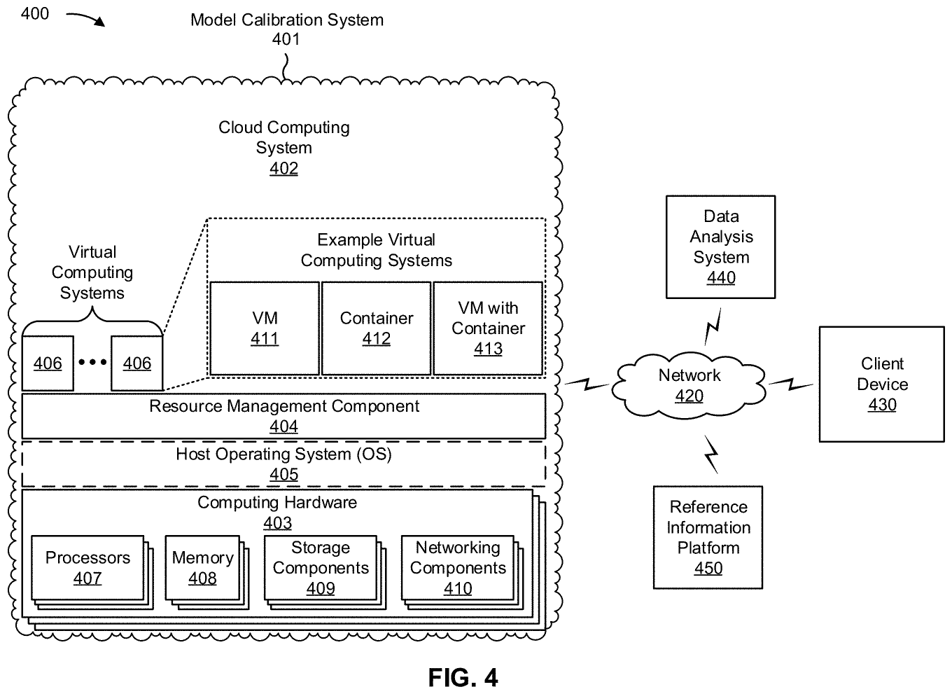

FIG. 4 is a diagram of an example environment 400 in which systems and/or methods described herein may be implemented. As shown in FIG. 4, environment 400 may include a model calibration system 401, which may include one or more elements of and/or may execute within a cloud computing system 402. The cloud computing system 402 may include one or more elements 403-413, as described in more detail below. As further shown in FIG. 4, environment 400 may include a network 420, a client device 430, a data analysis system 440, and/or a reference information platform. Devices and/or elements of environment 400 may interconnect via wired connections and/or wireless connections.

The cloud computing system 402 includes computing hardware 403, a resource management component 404, a host operating system (OS) 405, and/or one or more virtual computing systems 406. The resource management component 404 may perform virtualization (e.g., abstraction) of computing hardware 403 to create the one or more virtual computing systems 406. Using virtualization, the resource management component 404 enables a single computing device (e.g., a computer, a server, and/or the like) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

Computing hardware 403 includes hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, one or more storage components 409, and/or one or more networking components 410. Examples of a processor, a memory, a storage component, and a networking component (e.g., a communication component) are described elsewhere herein.

The resource management component 404 includes a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, and/or the like) or a virtual machine monitor, such as when the virtual computing systems 406 are virtual machines 411. Additionally, or alternatively, the resource management component 404 may include a container manager, such as when the virtual computing systems 406 are containers 412. In some implementations, the resource management component 404 executes within and/or in coordination with a host operating system 405.

A virtual computing system 406 includes a virtual environment that enables cloud-based execution of operations and/or processes described herein using computing hardware 403. As shown, a virtual computing system 406 may include a virtual machine 411, a container 412, a hybrid environment 413 that includes a virtual machine and a container, and/or the like. A virtual computing system 406 may execute one or more applications using a file system that includes binary files, software libraries, and/or other resources required to execute applications on a guest operating system (e.g., within the virtual computing system 406) or the host operating system 405.

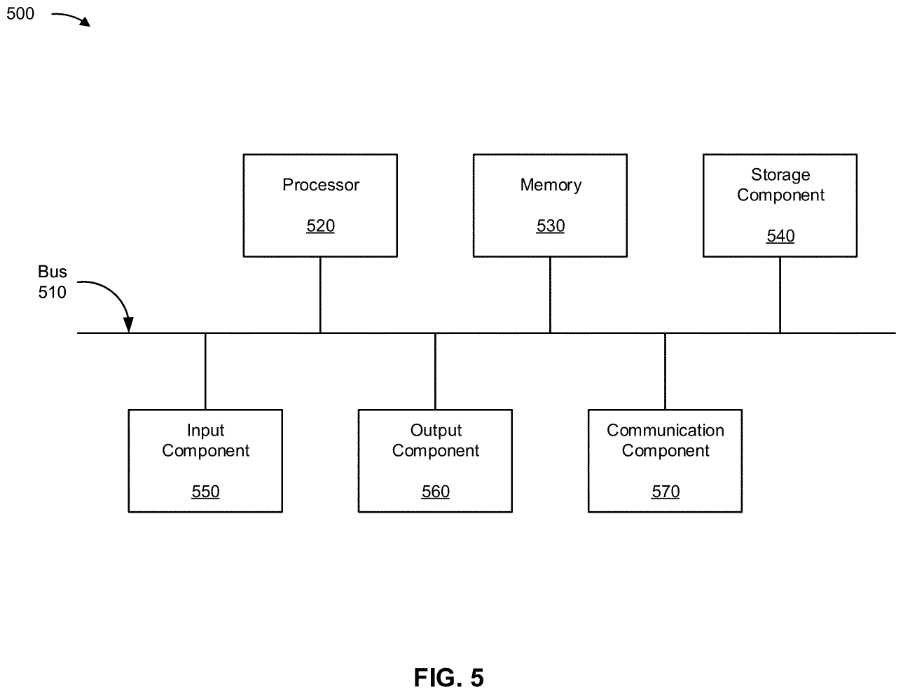

Although the model calibration system 401 may include one or more elements 403-413 of the cloud computing system 402, may execute within the cloud computing system 402, and/or may be hosted within the cloud computing system 402, in some implementations, the model calibration system 401 may not be cloud-based (e.g., may be implemented outside of a cloud computing system) or may be partially cloud-based. For example, the model calibration system 401 may include one or more devices that are not part of the cloud computing system 402, such as device 500 of FIG. 5, which may include a standalone server or another type of computing device. The model calibration system 401 may perform one or more operations and/or processes described in more detail elsewhere herein.

Network 420 includes one or more wired and/or wireless networks. For example, network 420 may include a cellular network, a public land mobile network (PLMN), a local area network (LAN), a wide area network (WAN), a private network, the Internet, and/or the like, and/or a combination of these or other types of networks. The network 420 enables communication among the devices of environment 400.

The client device 430 may include one or more devices capable of receiving, generating, storing, processing, and/or providing information described herein. For example, the client device 430 may provide the set of rules and/or the calibration for calibrating an AI model. Additionally, or alternatively, the client device 430 may provide input data that is to be analyzed by the data analysis platform. The client device 430 may include a communication device and/or a computing device. For example, the client device 430 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. The client device 430 may communicate with one or more other devices of environment 400, as described elsewhere herein.

The data analysis system 440 may include one or more devices capable of receiving, generating, storing, processing, and/or providing information described herein. For example, the data analysis system 440 may analyze the input data provided by the client device 430, the data analysis system 440 may be associated with and/or a provide an AI model to the model calibration system for calibration, or the like.

The reference information platform 450 may include one or more devices capable of receiving, generating, storing, processing, and/or providing information described herein. For example, the reference information platform 450 may provide analytics and/or reference information (e.g., benchmarks, thresholds, statistics, or the like) associated with one or more rules. For instance, the reference information platform 450 may provide analytics associated with a zip code, a gender, an age or age group, and/or a group of individuals relative to a particular qualification for a service, product, membership, or the like.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to model calibration system 401, client device 430, data analysis system 440, and/or reference information platform 450. In some implementations, model calibration system 401, client device 430, data analysis system 440, and/or reference information platform 450 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

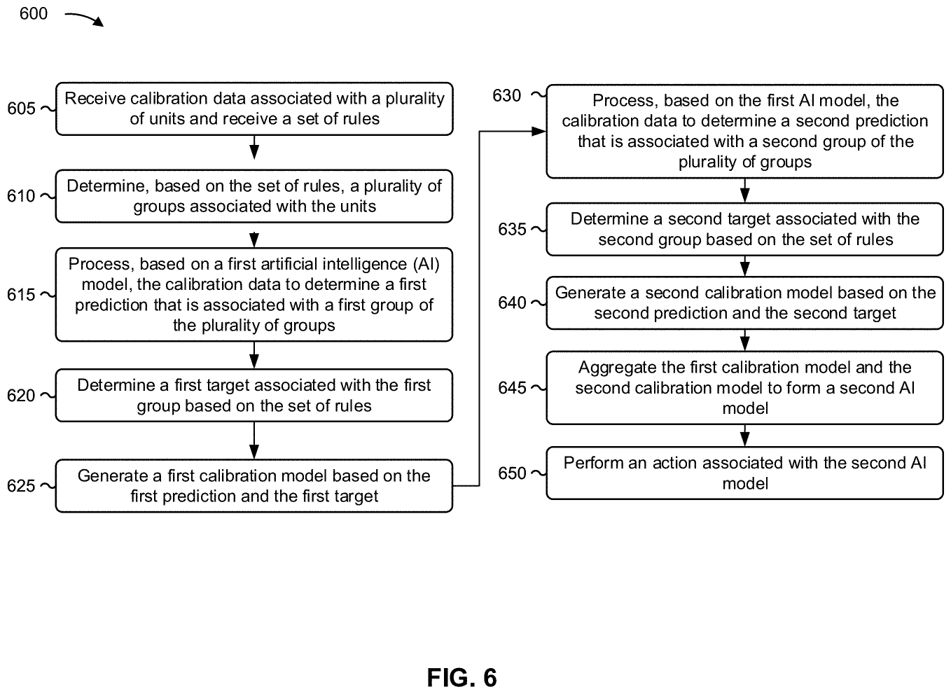

FIG. 6 is a flowchart of an example process 600 associated with calibrating an AI model. In some implementations, one or more process blocks of FIG. 6 may be performed by a model calibration system (e.g., model calibration system 101). In some implementations, one or more process blocks of FIG. 6 may be performed by another device or a group of devices separate from or including the model calibration system, such as a client device (e.g., client device 430), a data analysis system (e.g., data analysis system 440), and/or a reference information platform (e.g., reference information platform 450). Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include receiving calibration data associated with a plurality of units and receiving a set of rules (block 605). For example, the model calibration system may receive calibration data associated with a plurality of units and a set of rules, as described above.

As further shown in FIG. 6, process 600 may include determining, based on the set of rules, a plurality of groups associated with the units (block 610). For example, the model calibration system may determine, based on the set of rules, a plurality of groups associated with the units, as described above.

As further shown in FIG. 6, process 600 may include processing, based on a first artificial intelligence (AI) model, the calibration data to determine a first prediction that is associated with a first group of the plurality of groups (block 615). For example, the model calibration system may process, based on a first AI model, the calibration data to determine a first prediction that is associated with a first group of the plurality of groups, as described above.

As further shown in FIG. 6, process 600 may include determining a first target associated with the first group based on the set of rules (block 620). For example, the model calibration system may determine a first target associated with the first group based on the set of rules, as described above.

As further shown in FIG. 6, process 600 may include generating a first calibration model based on the first prediction and the first target (block 625). For example, the model calibration system may generate a first calibration model based on the first prediction and the first target, as described above.

As further shown in FIG. 6, process 600 may include processing, based on the first AI model, the calibration data to determine a second prediction that is associated with a second group of the plurality of groups (block 630). For example, the model calibration system may process, based on the first AI model, the calibration data to determine a second prediction that is associated with a second group of the plurality of groups, as described above.

As further shown in FIG. 6, process 600 may include determining a second target associated with the second group based on the set of rules (block 635). For example, the model calibration system may determine a second target associated with the second group based on the set of rules, as described above.

As further shown in FIG. 6, process 600 may include generating a second calibration model based on the second prediction and the second target (block 640). For example, the model calibration system may generate a second calibration model based on the second prediction and the second target, as described above.

As further shown in FIG. 6, process 600 may include aggregating the first calibration model and the second calibration model to form a second AI model (block 645). For example, the model calibration system may aggregate the first calibration model and the second calibration model to form a second AI model, as described above.

As further shown in FIG. 6, process 600 may include performing an action associated with the second AI model (block 650). For example, the model calibration system may perform an action associated with the second AI model, as described above.

Process 600 may include additional implementations, such as any single implementation or any combination of implementations described below and/or in connection with one or more other processes described elsewhere herein.

In a first implementation, the first AI model comprises a pretrained model that is trained based on historical training data associated with one or more historical groups associated with one or more of the plurality of groups.

In a second implementation, the first prediction is associated with a first error rate that is associated with the first AI model processing the first group, and the second prediction is associated with a second error rate associated with the first AI model processing the second group. In a third implementation, the first target and the second target are associated with a same target error rate for the first error rate and the second error rate. In a fourth implementation, the target error rate is associated with an overall average error rate associated with the plurality of units.

In a fifth implementation, the first calibration model and the second calibration model are generated using at least one of a scaling technique, or an isotonic regression technique. In a sixth implementation, performing the action comprises at least one of processing the calibration data based on the second AI model to determine calibrated predictions associated with the plurality of units, replacing, in a data analysis system, the first AI model with the second AI model, or processing, using the second AI model, received input data associated with a unit that is associated with one or more of the plurality of groups.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, calibration data associated with a plurality of units and receiving a set of rules;
determining, by the device and based on the set of rules, a plurality of groups associated with the units;
processing, by the device and based on a first artificial intelligence (AI) model, the calibration data to determine a first prediction that is associated with a first group of the plurality of groups;
determining, by the device, a first target associated with the first group based on the set of rules;
generating, by the device, a first calibration model based on the first prediction and the first target; and
processing, by the device and based on the first AI model, the calibration data to determine a second prediction that is associated with a second group of the plurality of groups;
determining, by the device, a second target associated with the second group based on the set of rules;
generating, by the device, a second calibration model based on the second prediction and the second target;
aggregating, by the device, the first calibration model and the second calibration model to form a second AI model; and
performing, by the device, an action associated with the second AI model.

2. The method of claim 1, wherein the first AI model comprises a pretrained model that is trained based on historical training data associated with one or more historical groups associated with one or more of the plurality of groups.

3. The method of claim 1, wherein the first prediction is associated with a first error rate that is associated with the first AI model processing the first group; and
wherein the second prediction is associated with a second error rate associated with the first AI model processing the second group.

4. The method of claim 3, wherein the first target and the second target are associated with a same target error rate for the first error rate and the second error rate.

5. The method of claim 4, wherein the target error rate is associated with an overall average error rate associated with the plurality of units.

6. The method of claim 1, wherein the first calibration model and the second calibration model are generated using at least one of:
a scaling technique; or
an isotonic regression technique.

7. The method of claim 1, wherein performing the action comprises at least one of:
processing the calibration data based on the second AI model to determine calibrated predictions associated with the plurality of units;
replacing, in a data analysis system, the first AI model with the second AI model; or
processing, using the second AI model, received input data associated with a unit that is associated with one or more of the plurality of groups.

8. A device, comprising:
one or more memories; and
one or more processors, communicatively coupled to the one or more memories, configured to:
receive a pretrained artificial intelligence (AI) model and calibration data associated with a plurality of units and a set of rules;
determine, based on the set of rules, a plurality of groups associated with the plurality of units;
assign a first subset of the calibration data to a first group of the plurality of groups and a second subset of the calibration data to a second group of the plurality of groups;
process, based on the pretrained AI model, the first subset of the calibration data to determine a first prediction that is associated with the first group;
process, based on the pretrained AI model, the second subset of the calibration data to determine a second prediction that is associated with the second group;
determine, based on the set of rules, a first target associated with the first group and a second target associated with the second group;
generate a first calibration model based on the first prediction and the first target and a second calibration model based on the second prediction and the second target; and
aggregate the first calibration model and the second calibration model to form a calibrated AI model; and
perform an action associated with the calibrated AI model.

9. The device of claim 8, wherein a unit, of the plurality of units, is associated with the first subset of the calibration data and the second subset of the calibration data.

10. The device of claim 8, wherein the set of rules define respective features of the plurality of groups and respective fairness objectives for the plurality of groups.

11. The device of claim 8, wherein the first group is associated with a first attribute of a feature and the second group is associated with a second attribute of the feature,
wherein the first calibration model and the second calibration model are associated with the feature.

12. The device of claim 8, wherein the first group is associated with a first feature and the second group is associated with a second feature,
wherein the first calibration model is associated with the first feature, and
wherein the second calibration model is associated with a second feature.

13. The device of claim 8, wherein the first calibration model and the second calibration model are generated using at least one of:
a scaling technique; or
an isotonic regression technique.

14. The device of claim 8, wherein the one or more processors, when performing the action, are configured to:
replace, in a data analysis system, the pretrained AI model with the calibrated AI model;
receive input data associated with a unit that is associated with one or more of the plurality of groups; and
process, based on the calibrated AI model, the input data to determine a prediction associated with the input data.

15. A non-transitory computer-readable medium storing a set of instructions, the set of instructions comprising:
one or more instructions that, when executed by one or more processors of a device, cause the device to:
receive calibration data associated with a plurality of units and a set of rules;
determine, based on the set of rules, a plurality of groups associated with the plurality of units;
process the calibration data based on a pretrained artificial intelligence (AI) model;
determine, based on processing the calibration data, a prediction that is associated with a group of the plurality of groups;
determine, based on the set of rules, a target associated with the group based on the set of rules;
generate a calibration model based on the prediction and the target; and
aggregate the calibration model with another calibration model that is associated with another group of the plurality of groups to form a calibrated AI model; and
perform an action associated with the calibrated AI model.

16. The non-transitory computer-readable medium of claim 15, wherein the set of rules define respective features of the plurality of groups and respective fairness objectives for the plurality of groups.

17. The non-transitory computer-readable medium of claim 15, wherein the pretrained AI model is trained to determine a qualification of a unit based on whether a profile of the unit satisfies a profile threshold.

18. The non-transitory computer-readable medium of claim 17, wherein the prediction comprises an error rate that is associated with the pretrained AI model determining that units of the group are associated with profiles that satisfy the profile threshold.

19. The non-transitory computer-readable medium of claim 18, wherein the target comprises an average error rate associated with the pretrained AI model determining that profiles of the plurality of units satisfy the profile threshold.

20. The non-transitory computer-readable medium of claim 15, wherein the one or more instructions, that cause the device to perform the action, cause the device to:
retrain the pretrained AI model based on the calibrated AI model and the set of rules;
replace, in a data analysis system, the pretrained AI model with the calibrated AI model; or
process received input data associated with one or more of the plurality of groups using the calibrated model.
